(19) United States
(12) Patent Application Publication
(10) Pub. No.: US 2025/0196833 A1
(43) Pub. Date: Jun. 19, 2025

(54) BRAKE CALIPER FOR A DISC BRAKE

(71) Applicant: BREMBO S.p.A., Curno (Bergamo) (IT)

(72) Inventors: Alessandro BERTAGNA, Curno (Bergamo) (IT); Andrea CASADIO, Curno (Bergamo) (IT); Damiano TODISCO, Curno (Bergamo) (IT); Filippo CORNARA, Curno (Bergamo) (IT); Gianluca COSTA, Curno (Bergamo) (IT)

(73) Assignee: BREMBO S.p.A., Curno (Bergamo) (IT)

(21) Appl. No.: 18/843,007

(22) PCT Filed: Mar. 1, 2023
(86) PCT No.: PCT/IB2023/051891

§ 371 Date: Aug. 30, 2024

(30) Foreign Application Priority Data
Mar. 3, 2022 (IT) 102022000003986

(51) Int. Cl. B60T 13/74; B60T 8/171; B60T 8/172; F16D 55/226; F16D 65/18; F16D 66/00; F16D 121/24; F16D 127/06

(52) U.S. Cl. CPC B60T 13/746; B60T 8/171; B60T 8/172; F16D 55/226; F16D 65/18; F16D 66/00; F16D 2066/003; F16D 2066/005; F16D 2121/24; F16D 2127/06; F16D 2200/0004; F16D 2200/0034

(57) ABSTRACT

A brake caliper has a caliper body having two side walls delimiting a disc space for accommodating a portion of a brake disc, a connection structure extending straddling the disc space and connecting the side walls to each other, and a pad housing for accommodating at least one pad. A transmission housing is connected to the caliper body so that a front wall of the transmission housing faces the disc space. Thrust members bias the pads against the brake disc along an actuation axis. A control housing supports and houses an electric motor having a drive shaft. and configured to generate and transfer mechanical power to the thrust members. A brake control unit controls the electric motor. The drive shaft protrudes from a front side of the electric motor facing the caliper body. The brake control unit has an electronic board extending in a transverse direction with respect to the actuation axis.

### FIELD OF THE INVENTION

The present invention relates to a brake caliper for a disc brake, in particular for an electromechanical disc brake, as well as to a disc brake provided with such a brake caliper.

### BACKGROUND ART

Brake calipers for electromechanical disc brakes are known, which comprise a gearmotor associated with an actuator which converts the torque generated by the gearmotor into a braking force directed against the disc brake pads.

These brake calipers are further connected to an electronic control unit (“ECU”), also known as a brake control unit (“BCU”), configured to receive signals and electric power from the vehicle on which the brake caliper is installed, and to command and control the actuation of the electric/electronic components of the brake caliper.

The BCU can be a component outside the brake caliper, or it can be integrated inside the brake caliper itself.

The integration of the BCU inside the brake caliper brings several technical advantages, including ensuring a simplified management of the brake caliper, due to the fact that the BCU is not a separate component installed in the vehicle, but is directly integrated into the brake caliper.

An additional advantage achievable by integrating the BCU into the brake caliper stems from the fact that the electric power entering in the BCU is a direct current, while the electric power output from the BCU and entering in the electric/electronic components of the brake caliper, including an electric motor, is a three-phase current. The wiring between the BCU and the electric motor generates strong electromagnetic fields which can cause disturbances to the additional electronic components installed in the vehicle. This drawback is avoided by integrating the BCU into the brake caliper, which allows confining the electromagnetic radiation generated by the three-phase supply current to the electric/electronic components of the brake caliper in the caliper assembly.

An additional advantage achievable by integrating the BCU in the brake caliper is that of an overall optimization of the braking system, given the high integration of the electric/electronic components of the braking system in the brake caliper, and the overall reduction in system components with respect to the configuration in which the BCU is installed in the vehicle separately from the brake caliper.

Nevertheless, the integration of the BCU inside the brake caliper implies several technical problems.

A first technical problem is the high overheating to which the brake caliper is subjected due to braking power dissipation, which can affect the operation of the BCU being particularly sensitive to thermal loads.

An additional technical problem is due to the high vibrations and mechanical stresses to which the brake caliper mounted on the vehicle wheel is subjected, which can be critical to the electric interconnections of the BCU.

An additional technical problem is that the BCU generally consists of one or more electronic boards having a large and thin surface area, which is difficult to incorporate in the brake caliper volume because of the limited space inside the wheel.

### Solution

It is the object of the present invention to provide a brake caliper for a disc brake having features such as to obviate at least some of the drawbacks of the prior art.

It is a particular object of the present invention to provide a brake caliper for a disc brake, in which the BCU is integrated into the brake caliper with small overall dimensions.

It is a further particular object of the present invention to provide a brake caliper for a disc brake, in which the BCU is less subject to mechanical stresses.

It is a further particular object of the present invention to provide a brake caliper for a disc brake in which the BCU is less subject to thermal loads.

These and other objects are achieved by a brake caliper for a disc brake according to claim 1.

The dependent claims relate to preferred and advantageous embodiments of the present invention.

### DRAWINGS

In order to better understand the invention and appreciate the advantages thereof, some non-limiting exemplary embodiments thereof will be described below with reference to the accompanying drawings, in which:

FIG. 1 is a perspective view of a brake caliper for a disc brake according to an embodiment of the invention;

FIG. 2 is a further perspective view of the brake caliper for a disc brake depicted in FIG. 1;

FIG. 3 is a side view of the brake caliper for a disc brake depicted in FIG. 1;

FIG. 4 is an upper view of the brake caliper for a disc brake depicted in FIG. 1:

FIG. 5 is a cross section view of the brake caliper for a disc brake depicted in FIG. 4;

FIG. 6 is a further cross section view of the brake caliper for a disc brake depicted in FIG. 4;

FIG. 7 is a longitudinal section view of the brake caliper for a disc brake depicted in FIG. 4;

FIG. 8 is a further longitudinal section view of the brake caliper for a disc brake depicted in FIG. 4;

FIG. 9 is a front view of the brake caliper for a disc brake depicted in FIG. 1;

FIG. 10 is a longitudinal section view of the brake caliper for a disc brake depicted in FIG. 9;

FIG. 11 is a further longitudinal section view of the brake caliper for a disc brake depicted in FIG. 9;

FIG. 12 is a rear perspective view of a brake caliper for a disc brake showing visible and invisible details according to an embodiment of the invention;

FIG. 13 is a diagrammatic view of a brake caliper for a disc brake according to an embodiment of the invention;

FIG. 14 is an exploded view of a component of a brake caliper for a disc brake according to an embodiment of the invention;

FIG. 15 is a further exploded view of the component depicted in FIG. 14 in a partially assembled configuration.

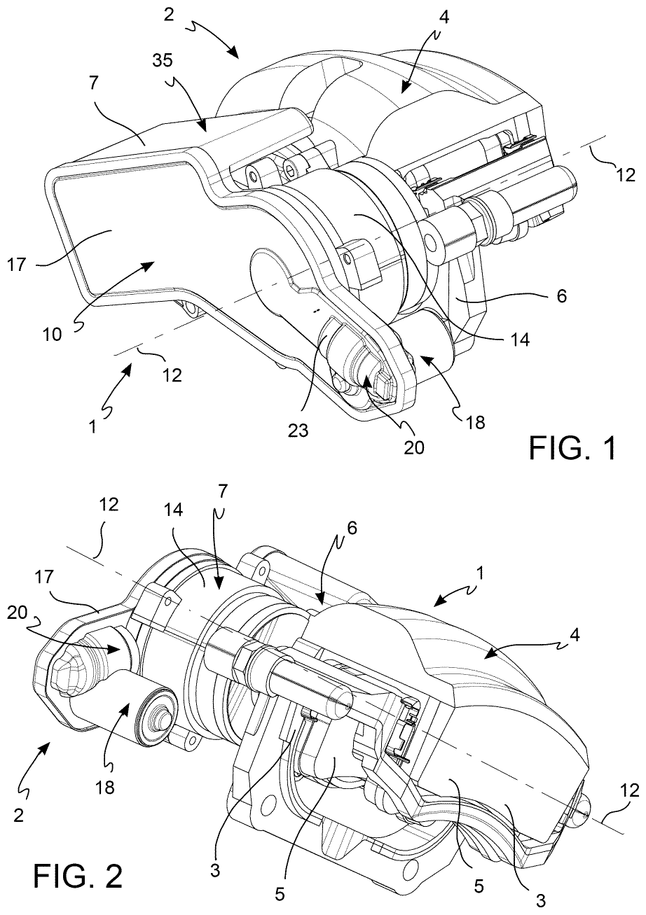

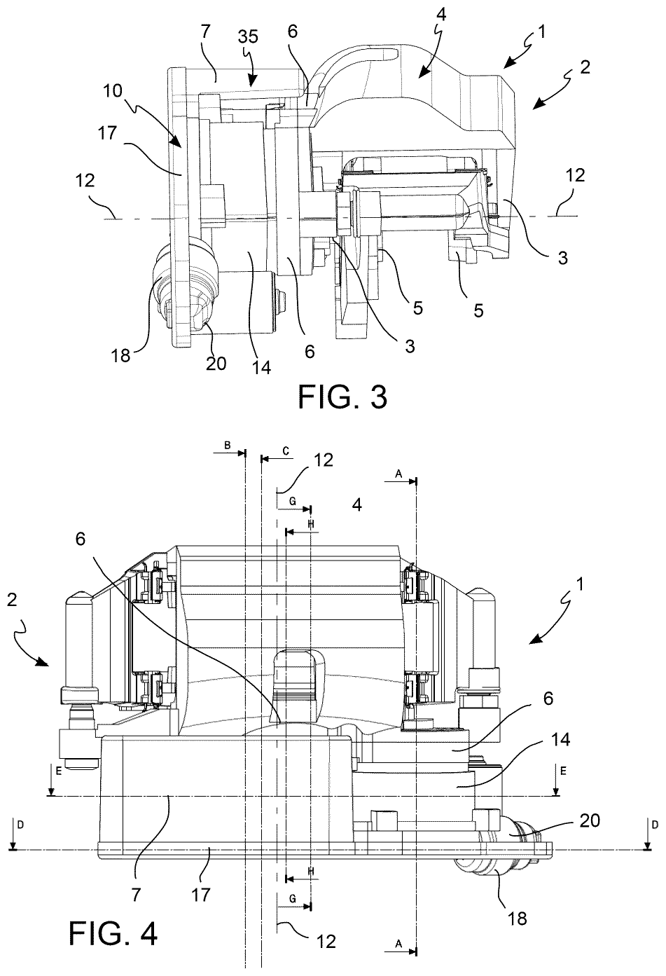

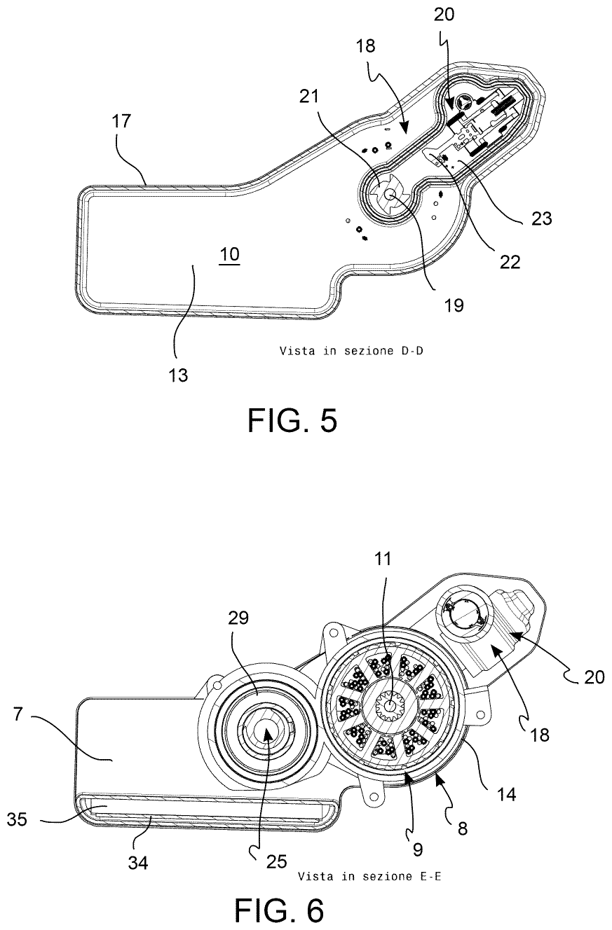

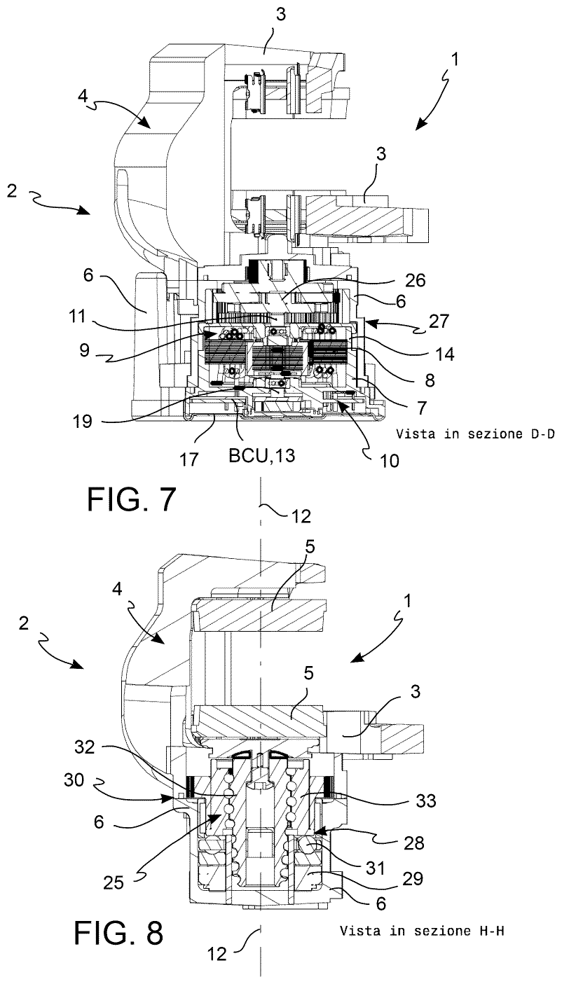

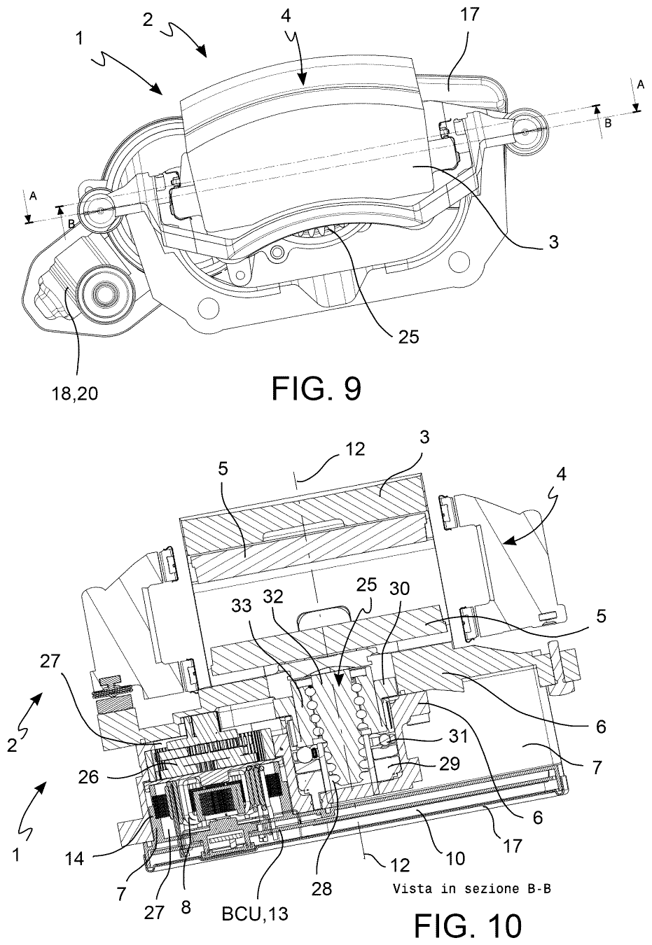

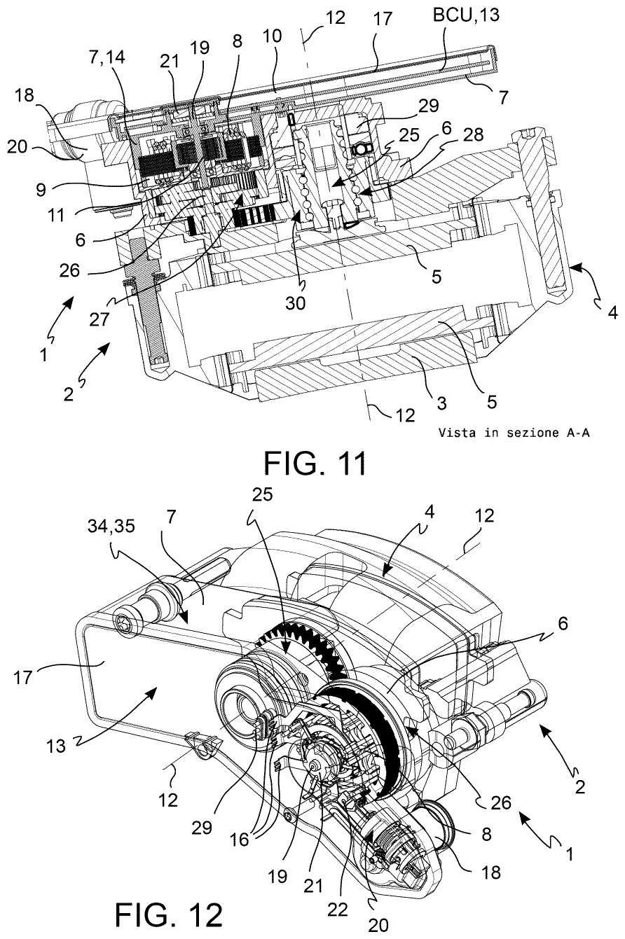

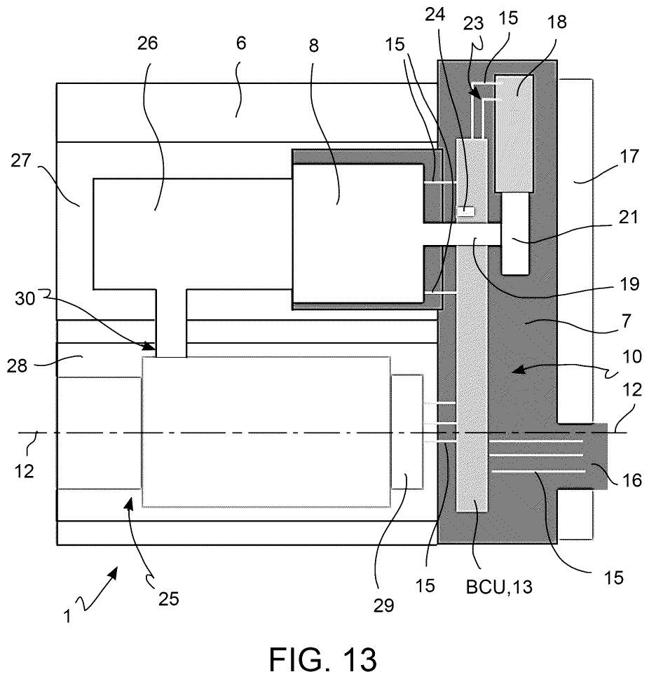

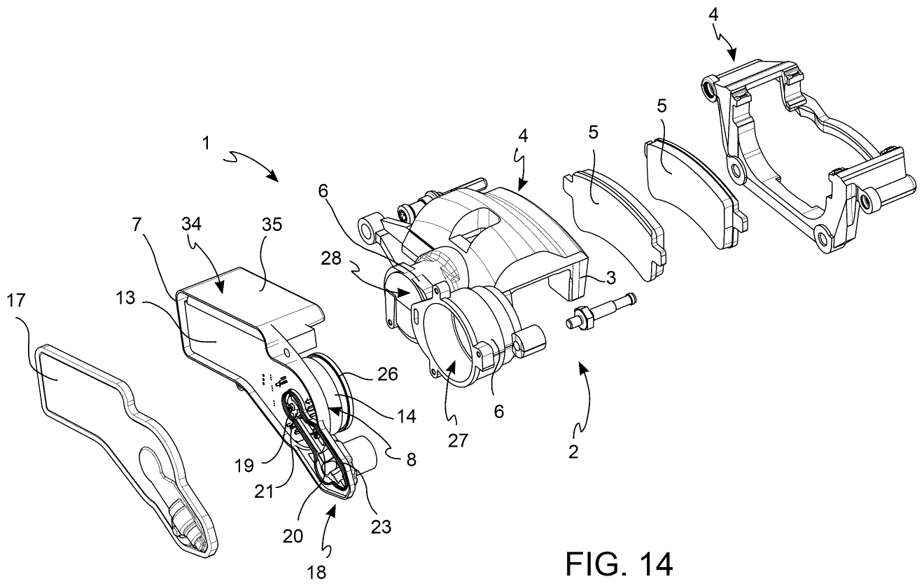

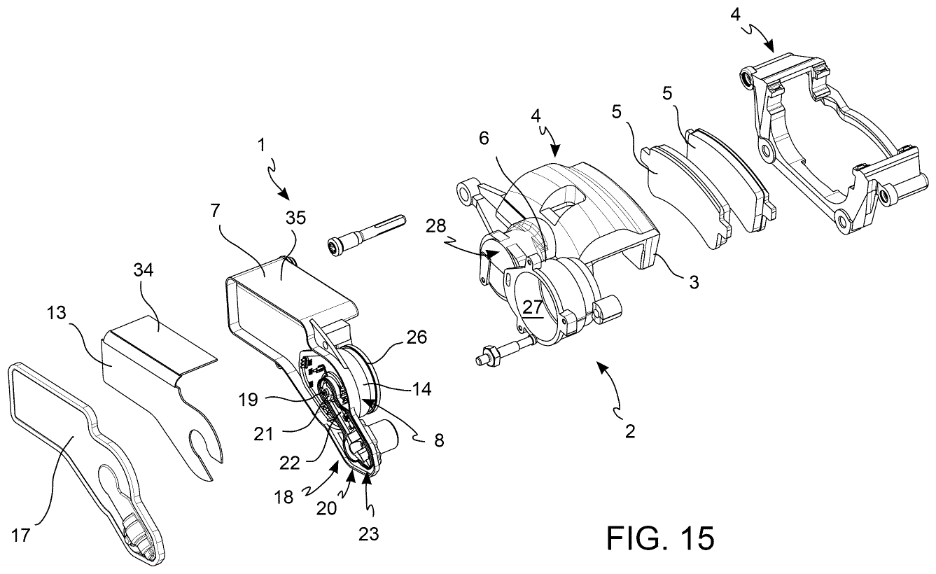

### DESCRIPTION OF SOME PREFERRED EMBODIMENTS

In the following description, the term “front” orientation refers to the orientation of sides, faces, surfaces, etc., in the forward (braking) direction of the thrust means, the term “rear” orientation refers to the orientation of sides, faces, surfaces, etc., in the retraction direction of the thrust means, unless otherwise specified. “Electrically linked” and “electrically connected” mean a connection for the transmission of electric power and/or electric signals.

With reference to the figures, a brake caliper 1 for a disc brake 2 comprises a caliper body 4. The caliper body 4 comprises two side walls 3 mutually spaced apart and delimiting a disc space for accommodating a portion of a brake disc.

The caliper body 4 further comprises a connection structure which extends straddling the disc space and connects the side walls 3 to each other.

The caliper body 4 further comprises at least one pad housing formed in each of the side walls 3 and adapted to accommodate at least one pad 5.

The brake caliper 1 further comprises a transmission housing 6.

The transmission housing 6 extends between a front end thereof and a rear end thereof.

The transmission housing 6 is connected to the caliper body 4 so that the front wall of transmission housing 6 faces the disc space.

The brake caliper 1 further comprises thrust means constrained to one or both side walls 3 and adapted to bias the pads 5 against the brake disc along an actuation axis 12 transverse to the side walls 3.

The thrust means are at least partially housed inside the transmission housing 6.

The brake caliper 1 further comprises a control housing 7 connected to the transmission housing 6 at the rear wall of the transmission housing 6.

The control housing 7 supports and houses an electric motor 8 and a brake control unit (“BCU”).

An electric motor 8 comprises a drive shaft 11. Moreover, the electric motor 8 is configured to generate and transfer a mechanical power to the thrust means by the drive shaft 11.

The electric motor 8 is at least partially housed inside a motor housing 9 formed by the control housing 7.

The brake control unit is configured to control the electric motor 8.

Furthermore, the brake control unit is housed within a control compartment 10 defined by the control compartment 7.

The electric motor 8 is electrically connected to the brake control unit.

The drive shaft 11 extends in a direction parallel to the actuation axis 12 and protrudes from a front side of the electric motor 8 facing the caliper body 4.

The brake control unit comprises at least one electronic board 13.

The at least one electronic board 13 extends in a transverse direction with respect to the actuation axis 12.

Advantageously, the configuration described above allows integrating a brake control unit in a brake caliper with small total overall dimensions.

With added advantage, a control housing 7 thus configured, with the electric motor 8 and the brake control unit housed therein, can be assembled and tested as an independent subassembly from brake caliper 1, then being connectable to the brake caliper 1.

According to an embodiment of the invention, the electric motor 8 is entirely housed inside the motor housing 9. Preferably, the electric motor 8 is welded to the control housing 7, inside the motor housing 9.

According to an embodiment, the motor housing 9 is substantially cylindrical in shape, being defined by a motor housing wall 14.

Preferably, the motor housing wall 14 is cylindrical in shape and coaxial to the drive shaft 11.

The electric motor 8 comprises a rotor and a stator. According to an embodiment, the stator and the motor housing wall 14 are made in one piece, preferably by molding. Specifically, the control housing 7, the motor housing wall 14 and the stator of electric motor 8 are made in one piece by single overmolding. Advantageously, this allows obtaining structural continuity between the electric motor 8 and the control housing 7, avoiding discontinuities due to welding, and in particular avoiding the creation of welds between contiguous plastic materials.

According to an embodiment, the motor housing wall 14 of the control housing 7 extends into the transmission housing 6, through the rear wall of the transmission housing 6.

According to this embodiment, the electric motor 8 is positioned inside the transmission housing 6.

Advantageously, such a configuration reduces the overall dimensions of the brake caliper because the electric motor, housed in the control housing, is incorporated in the transmission housing.

### Control Housing 7

According to an embodiment, the control housing 7 is a distinct component separated from the transmission housing 6. The control housing 7 is connected to the transmission housing 6, preferably by screwing.

According to an embodiment, at least one portion of the at least one electronic board 13 faces a rear side of the electric motor 8 opposite to the front side of the electric motor 8 from which the drive shaft 11 extends.

According to this embodiment, electric connectors 15 extend from the rear side of the electric motor 8 to the at least one electronic board 13, so as to electrically connect the electric motor 8 to the at least one electronic board 13.

According to an embodiment, the control housing 7 comprises a main electric connector 16. According to an embodiment, the main electric connector 16 is a male type connector.

The main electric connector 16 configured to be accessible from outside the brake caliper 1, to receive electric power and signals from an electronic control unit installed in the vehicle, and to transfer electric power and signals to the brake control unit.

According to an embodiment, the main electric connector 16 is positioned on a rear side of the control housing 7 facing away from the transmission housing 6.

According to an embodiment, the main electric connector 16 faces a side of the at least one electronic board 13 opposite to the side of the electronic board 13 electrically connected to the electric motor 8. Alternatively, the main electronic connector 16 faces an edge of the at least one electronic board 13, in a position substantially coplanar to the plane defined by the at least one electronic board 13.

According to an embodiment, the main electric connector 16 comprises terminals positioned on an outer side of the brake caliper 1 facing a wiring with the vehicle.

According to an embodiment, the terminals are positioned in a direction perpendicular to the at least one electronic board 13 or are positioned in a direction parallel to the at least one electronic board 13. Alternatively, the terminals can be positioned in any orientation, depending on the structural requirements of the brake caliper 1 or the shape of the control housing 7.

According to a further embodiment, the transmission housing 6 is made of a material having a higher thermal conductivity than the thermal conductivity of the material of which the control housing 7 is made.

Advantageously, such a configuration reduces the thermal loads acting on the electric/electronic components inside the control housing 7, because the thermal load from the transmission housing 6 is hindered by the lower thermal conductivity of the control housing 7.

According to a preferred embodiment, the control housing 7 is made of a polymer material.

According to a preferred embodiment, the transmission housing is made of a metal material.

According to an embodiment, the control compartment 10 of the control housing 7 is open at the rear side of the control housing 7.

According to an embodiment, the brake caliper 1 comprises a metal cover 17 connected to the control housing 7 so as to close the rear side of the control housing 7.

The metal cover 17 is configured to dissipate the heat from the control housing 7 to the outside of the brake caliper 1.

The metal cover 17 is made of a material having a higher thermal conductivity than the thermal conductivity of the material of which the control housing 7 is made.

Advantageously, the metal cover 17 achieves an effective dissipation of the heat of the control housing 7 so as to reduce the thermal load to which the electric/electronic components inside the control housing 7, such as the at least one electronic board 13, are subjected.

With added advantage, the metal cover 17 ensures the sealing of the electric/electronic components positioned inside the control housing 7.

According to an embodiment, the control housing 7 is shaped so as to prevent contact between the metal cover 17 and the transmission housing 6.

Advantageously, the lack of contact between the metal cover 17 and the transmission housing 6 avoids the transmission housing 6 from transferring heat to the metal cover 17 by thermal conduction, and thus allows the metal cover 17 to dissipate the heat of the control housing 7 more effectively.

With added advantage, according to this configuration, the control housing 7, having lower thermal conductivity than the transmission housing 6 and the metal cover 17, acts as a thermal insulator between the transmission housing 6 and the metal cover 17, thus promoting effective dissipation of its heat by means of the metal cover 17. Indeed, the control housing 7 helps to keep the metal cover cooler by isolating it from the heat flow from the transmission housing 6, so as to promote more effective cooling, by means of metal cover 17, of the electric/electronic components inside the control housing 7.

According to an embodiment, the metal cover 17 is connected to the control housing 7 so that it is in direct contact with the brake control unit.

Alternatively, the metal cover 17 is in indirect contact with the brake control unit, and highly thermally conductive means are interposed between the metal cover 17 and the brake control unit. The highly thermally conduction means can be, for example, heat conductive paste or a pad made of high thermal conductivity material, also known as a “thermal pad”.

According to an embodiment, the drive shaft 11 comprises a rear drive shaft end 19 of protruding from a rear side of the electric motor 8 facing to be opposite to the transmission housing 6, i.e., opposite to the front side of the electric motor 8.

According to an embodiment, the rear drive shaft end 19 extends through the at least one electronic board 13.

Specifically, the rear drive shaft end 19 extends through a through-hole made in the at least one electronic board 13.

According to an embodiment, the brake caliper 1 comprises a position sensor 24 configured to detect the angular positioning of the electric motor 8.

According to an embodiment, the position sensor 24 is positioned inside the control housing 7 and is electrically connected to the brake control unit. Preferably, the position sensor 24 is positioned within the control compartment 10.

Preferably, the position sensor 24 is positioned at the rear drive shaft end 19, interposed between the electric motor 8 and the at least one electronic board 13. According to an embodiment, the position sensor 24 is mounted to the at least one electronic board 13 at the rear drive shaft end 19. According to an embodiment, the position sensor 24 comprises a detector element and a target, e.g., a magnetic ring. The detector element is configured to detect the target. According to this embodiment, the detector element is integrated in the at least one electronic board 13 while the target is mounted to the rear drive shaft end 19.

Advantageously, such a configuration reduces the overall dimensions due to the arrangement of a position sensor.

Moreover, such a configuration increases the effectiveness of the detection of the angular positioning of motor 8, given the proximity between the position sensor 24 and the rear drive shaft end 19 of the electric motor 8.

With added advantage, such a configuration simplifies the brake caliper 1 because multiple electric/electronic elements, such as the electric motor 8 and the position sensor 24, are electrically connected to the BCU itself integrated in the brake caliper 1.

According to an embodiment, the control housing 7 comprises a motor control board integrated in the electric motor 8. The motor control board is interconnected to the brake control unit and is configured to control the electric motor 8. According to this embodiment, the position sensor 24 is mounted to the motor control board. Specifically, the position sensor 24 is housed inside the motor housing 9.

According to an embodiment, the brake caliper 1 comprises an electromechanical parking brake 18.

The electromechanical parking brake 18 is housed inside the control compartment 10 of the control housing 7.

The electromechanical parking brake 18 is electrically connected to the brake control unit of the control housing 7.

Advantageously, such a configuration simplifies the brake caliper 1 because the multiple electric/electronic elements, such as the electric motor 8, the electromechanical parking brake 18 and/or the position sensor 24, are electrically connected to the BCU itself integrated in the brake caliper 1.

According to an embodiment, the electromechanical parking brake 18 comprises a toothed wheel 21 integrally fixed to the rear drive shaft end 19.

According to an embodiment, the toothed wheel 21 comprises at least one tooth. According to an embodiment, the number of teeth of the toothed wheel 21 is between one and thirty. Preferably, the number of teeth is between one and eight. According to an embodiment, the toothed wheel 21 has four teeth.

Furthermore, the electromechanical parking brake 18 comprises an electromechanical actuator 20. The electromechanical actuator 20 is configured to translate in the direction of the teeth of the toothed wheel 21, transverse to the rotation axis of the toothed wheel 21, i.e., transverse to the drive shaft 11.

Specifically, the electromechanical actuator is configured to translate in a plane transverse to the drive shaft 11 and parallel to the plane on which the at least one electronic board 13 of the brake control unit extends.

The electromechanical actuator 20 is configured to wedge itself between the teeth of the toothed wheel 21, following a command of the brake control unit, so as to prevent the rotation of the toothed wheel 21 and thus to lock the rotation of the drive shaft 11.

Advantageously, the electromechanical actuator 20 allows preserving the vehicle wheel lock carried out by the parking brake 18.

With added advantage, such a configuration allows integrating the parking brake 18 in the brake caliper 1, and in particular in the control housing 7, with small overall dimensions.

According to an embodiment, the electromechanical actuator 20 comprises a coupling element configured to be elastically biased against the toothed wheel 21 so as to be engaged between the teeth of the toothed wheel 21 and lock the rotation thereof.

The teeth of the toothed wheel 21 and the coupling element are shaped so that the coupling element allows the rotation of the toothed wheel 21 in one rotation direction, but prevents the rotation of the toothed wheel 21 in the opposite rotation direction f.

Moreover, the electromechanical actuator 20 comprises a selector element 22 sliding between a first position, in which it biases the coupling element to a coupling position between the teeth of the toothed wheel 21, and a second position, in which it biases the coupling element to an uncoupling position, spaced apart from the teeth of the toothed wheel 21.

According to an embodiment, the electromechanical actuator 20 comprises a cam member configured to allow the selector element 22 to slide to the first position, and actuate a mechanical lock which prevents the selector element 22 from returning to the second position, and preserve the parking braking. According to an embodiment, the electromechanical parking brake 18 comprises electromechanical means for releasing the mechanical lock implemented by the cam member, by means of which the selector element 22 can return to the second position, releasing the parking braking.

Advantageously, such a cam member makes the movement of the selector element 22 irreversible, so as to lock the electromechanical actuator 20 in the locking position of the toothed wheel 21, i.e., so as to preserve the parking braking carried out by the electromechanical parking brake 18, even in the absence of power supply.

According to this embodiment, the electromechanical parking braking 18 is activated by actuating the electric motor 8 in a rotation direction adapted to push at least one pad 5 against the brake disc until a braking force value suited for a parking braking is reached. Furthermore, the rotation of the electric motor 8 rotates the toothed wheel 21 in the same rotation direction. The selector element 22 is then translated so as to bias the coupling element against the toothed wheel 21, so as to lock the rotation of the toothed wheel 21. Optionally, after such an engagement, the electric motor 8 is rotated in the opposite direction to accommodate and ensure a complete engagement between the coupling element and the teeth of the toothed wheel 21. The actuation of the electric motor 8 is then interrupted.

According to an embodiment, the toothed wheel 21 comprises a plurality of teeth distributed along the periphery of the toothed wheel 21, being equidistant from one another according to a pitch with a predetermined value. According to an embodiment, the teeth of the toothed wheel 21 are substantially equal to one another.

According to an embodiment, the electromechanical parking brake 18 electrically connected to the brake control unit by means of the conductive track 23. The conductive track 23 is a coated copper sheet, cut and folded. Preferably, the conductive track 23 is overmolded on the control housing 7.

According to a preferred embodiment, the conductive track 23 is electrically connected to the electromechanical actuator 20 of the parking brake 18.

### Transmission Housing 6

According to an embodiment, the brake caliper 1 comprises an actuation device 25 and a transmission system 26.

The actuation device 25 is included in the thrust means.

The transmission system 26 is configured to transmit a torque generated by the electric motor 8 to the actuation device 25.

The actuation device 25 is configured to convert a torque received from the transmission system 26 into a braking force directed against the pads 5, along the actuation axis 12.

According to an embodiment, the transmission housing 6 defines a housing compartment in which the actuation device 25, the transmission system 26 and the electric motor 8 inserted into the motor housing 9 of the control housing 7 extending through the transmission housing 6 are all housed.

In an alternative embodiment, the transmission housing 6 defines a first housing compartment 27 and a second housing compartment 28.

The first housing compartment 27 and the second housing compartment 28 are mutually parallel and extend in a direction parallel to the actuation axis 12.

According to this embodiment, the electric motor 8, housed inside the control housing 7, is positioned inside the first housing compartment 27.

Specifically, the motor housing wall 14 defining the motor housing 9 in which the electric motor 8 is housed is inserted into the first housing compartment 27 of the transmission housing 6.

The transmission system 26, also connected to the electric motor 8, is positioned inside the first housing compartment 27.

Specifically, the transmission system 26 is connected to the drive shaft 11 of the electric motor 8.

Moreover, the actuation device 25 is positioned inside the second housing compartment 28.

The first housing compartment 27 is communicating with the second housing compartment 28, so that the transmission system 26 is connectable to the actuation device 25.

Advantageously, such a configuration greatly reduces the overall dimensions of transmission housing 1.

According to an embodiment, the first housing compartment 27 is substantially cylindrical in shape and coaxial to the drive shaft 11.

Furthermore, the second compartment housing 28 is substantially cylindrical in shape and coaxial to the actuation axis 12.

According to an embodiment, the first housing compartment 27 and the second housing compartment 28 are placed side by side and both at least partially facing the at least one pad 5. Specifically, the second housing compartment 28 faces the pad 5 and the first housing compartment 27 at least partially faces the pad 5.

According to an embodiment, the transmission housing 6 comprises a force sensor 29.

The force sensor 29 is connected to the actuation device 25, on a rear side of the actuation device 25 facing the control housing 7.

The force sensor 29 is configured to detect the braking force applied by the actuation device 25.

Specifically, the force sensor 29 is configured to receive and detect the reaction force discharged from the pads 5 on the actuation device 25 as opposed to the force applied by the actuation device 25, along the actuation axis 12.

Moreover, the force sensor 29 is electrically connected to the brake control unit.

Advantageously, such a configuration simplifies the brake caliper 1 because the multiple electric/electronic elements, such as the electric motor 8, the electromechanical parking brake 18 and/or the position sensor 24 and/or the force sensor 29 are electrically connected to the BCU itself integrated in the brake caliper 1.

According to an embodiment, a front side of the force sensor 29 faces the actuation device 25, and an opposite rear side of the force sensor 29 faces at least one portion of the at least one electronic board 13.

According to this embodiment, electric connectors 15 extend between the force sensor 29 and the at least one electronic board 13, through an interface between the transmission housing 6 and the control housing 7.

Advantageously, such a configuration reduces the overall dimensions of the force sensor 29 integrated in the brake caliper 1.

According to an embodiment, the brake control unit comprises at least one auxiliary electronic board 34. The auxiliary electronic board 34 is additional to the at least one electronic board 13 previously described.

The at least one auxiliary electronic board 34 is housed inside the control housing 7, in a transverse position with respect to the at least one electronic board 13.

Specifically, the at least one auxiliary electronic board 34 extends on a plane parallel to the actuation axis 12.

Preferably, the auxiliary electronic board 34 extends at least partially above the transmission housing 6.

Preferably, the auxiliary electronic 34 extends at least partially above the transmission housing 6, adjacent to the connection structure of the brake caliper 1.

According to this embodiment, the control housing 7 defines an auxiliary control compartment 35.

The control housing 35 extends in a substantially transverse direction with respect to the control compartment 10.

The at least one auxiliary electronic board 34 is housed in the auxiliary control compartment 35.

According to an embodiment, the at least one auxiliary electronic board 34 is connected, preferably is electrically connected, to the at least one electronic board 13 at an edge of the at least one electronic board 13.

The brake control unit comprising the at least one electronic board 13 and the at least one auxiliary electronic board 34 is thus substantially “L”-shaped.

According to an embodiment, the at least one electronic board 13 is a power board and the at least one auxiliary electronic board 34 is a logic board.

Advantageously, such a configuration minimizes the total dimensions of the brake control unit, and allows reducing the thermal and mechanical stresses to which the at least one electronic board 13 and the at least one auxiliary electronic board 34 are subjected.

### Actuation Device 25

According to an embodiment, the actuator device 25 comprises a recirculating ball screw-nut screw assembly 30 and a thrust bearing 31.

The recirculating ball screw-nut screw assembly 30 comprises a threaded shaft externally screwed onto the threaded shaft.

The threaded shaft and the nut screw extend in the direction of an actuation axis coaxial to the threaded shaft.

The threaded shaft 32 extends between a front end thereof and a rear end thereof.

According to an aspect of the invention, the nut screw 33 is configured to receive a torque generatable by a gearmotor, and a rotation of the nut screw 33 with respect to the threaded shaft 32 results in a translation of the threaded shaft 32 with respect to the nut screw 33 in the direction of the actuation axis.

Moreover, the thrust bearing 31 forms a reaction rest for the nut screw 33 in the direction of the actuation axis.

Furthermore, the thrust bearing 31 is positioned within the extension of the threaded shaft 32 between said front end and said rear end of the threaded shaft 32.

Advantageously, an actuation device 25 so configured has small axial dimensions. Indeed, the application of the torque of the gearmotor to the nut screw 33 avoids the system 26 for transmitting such a torque from being located at the rear end of the threaded shaft 32, resulting in a reduction of the axial dimensions.

With added advantage, since the thrust bearing 31 is positioned within the axial extension of the threaded shaft 32 between said front end and said rear end of the threaded shaft 32, the axial dimensions of the threaded shaft 32 and the thrust bearing 31 are at least partially superimposed, resulting in a reduction of the axial dimension of the entire actuation device 25.

According to an embodiment of the invention, the threaded shaft 32 is positioned passing through the thrust bearing 31.

Advantageously, such a configuration eliminates the axial dimension of the thrust bearing 31, as it is completely included within the axial dimension of the threaded shaft 32.

According to an embodiment, the thrust bearing 31 comprises a first ring and an opposite second ring.

In operational configuration, the first ring rotates with respect to the threaded shaft 32, while the second ring does not rotate with respect to the threaded shaft 32.

According to an embodiment, the first ring of the thrust bearing 31 is formed in one piece with the nut screw 33.

Advantageously, such a configuration further reduces the axial dimensions of the actuation device 25, since the dimension causable by the positioning of a specific rotating ring, opposite to the second ring, to be interposed between the nut screw 33 and the second ring, is avoided.

Specifically, the thrust bearing 31 comprises rolling members enclosed between two rolling tracks, a first rolling track of which is defined by the first ring and a second rolling track of which is defined by the second ring.

According to this embodiment, the nut screw 33 defines the first rolling track.

Alternatively, the thrust bearing 31 is distinct from the nut screw 33. Therefore, the first ring of the thrust bearing 31 is distinct from the nut screw 33 and is positioned to abut against the nut screw 33.

According to an embodiment, the thrust bearing 31 is a ball bearing. Alternatively, the thrust bearing 31 is a roller bearing.

According to an embodiment, the nut screw 33 forms an external toothing configured to receive a torque from a gearmotor.

According to an embodiment, the actuation device 25 comprises a force sensor 29.

The force sensor 29 is configured to detect the braking force applied by the actuation device 25.

Specifically, the force sensor 29 is configured to detect the force applied in the axial direction by the actuation device 25.

According to an embodiment, the force sensor 29 is positioned at least partially superimposed, in an axial direction, on the threaded shaft 32.

Advantageously, such a configuration further reduces the axial dimensions of the actuation device 25 because the respective axial dimensions of the threaded shaft 32 and the force sensor 29 are at least partially superimposed.

According to a preferred embodiment, the force sensor 29 is substantially annular in shape. According to an embodiment, the threaded shaft 32 is positioned passing through the force sensor 29.

Advantageously, such a configuration eliminates the axial dimension of the force sensor 29, as it is completely superimposed on the axial dimension of the threaded shaft 32.

According to an embodiment, the force sensor 29 is positioned adjacent to the thrust bearing 31, in the opposite direction to the nut screw 33.

Specifically, the force sensor 29 is adjacent to the second ring of thrust bearing 31.

According to this embodiment, the force sensor 29 is configured to detect the reaction force acting on the thrust bearing 31.

Advantageously, by detecting the force acting on the thrust bearing 31, the force sensor 29 is capable of determining the braking force applied by the actuation device 25.

According to an alternative embodiment, the force sensor 29 is positioned behind the threaded shaft 32, at the rear end of the threaded shaft 32.

According to an embodiment, the force sensor 29 is substantially cylindrical, discoidal, or axisymmetric in shape.

According to an embodiment, the actuation device 25 comprises a spacer.

The spacer is positioned to be coaxial to the threaded shaft 32, and is interposed between the force sensor 29 and the thrust bearing 31.

According to this embodiment, the spacer is configured to discharge, onto the force sensor 29, the reaction force acting on the thrust bearing 31.

Advantageously, by detecting the force from the thrust bearing 31 and acting on the spacer, the force sensor 29 is capable of determining the braking force applied by the actuation device 25.

According to an embodiment, the spacer is substantially cylindrical in shape.

According to an embodiment, the spacer defines a housing groove, and the thrust bearing 31 is housed in the housing groove of the spacer.

According to an embodiment, the actuation device 25 comprises a thrust plate.

The thrust plate is operatively connected to the front end of threaded shaft 32.

The thrust plate is configured to receive a braking force from the threaded shaft 32.

The braking force is generated by a translation of the threaded shaft 32 induced by a rotation of the nut screw 33.

Furthermore, the thrust plate is configured to discharge such a braking force onto a disc brake pad, so as to apply a braking force.

Preferably, the thrust plate is made of steel. According to an alternative embodiment, the thrust plate is made of aluminum or alloys thereof, or other light alloys.

According to an embodiment, the actuation device 25 comprises a joint interposed between the threaded shaft 32 and the thrust plate.

The cylindrical is configured to transfer force between the threaded shaft 32 and the thrust plate.

Moreover, the joint is configured to allow and accommodate rotational and/or translational displacements of the thrust plate with respect to the threaded shaft 32.

Advantageously, when the actuation device 25 is actuated to apply a braking force, the joint allows the thrust plate to be fully in contact with the disc brake pad even when the disc brake caliper deflects under the force applied by actuation device 25.

With added advantage, the joint avoids the generation of unbalanced loads acting on the recirculating ball 30 screw-nut screw assembly 33, otherwise causable by the deformation of the disc brake caliper under the action of braking force.

According to an embodiment, the thrust plate forms a front plate wall and a rear plate wall.

The front plate wall faces the disc brake pad, and the rear plate wall faces the threaded shaft 32.

The threaded shaft 32 forms a front shaft wall facing the rear plate wall of the thrust plate.

According to this embodiment, the joint is interposed between the rear plate wall and the front shaft wall.

According to an embodiment, the joint forms a conical or truncated cone wall, abutting against the thrust plate, and an opposite planar wall, abutting against the threaded shaft 32.

According to an embodiment, the rear plate wall defines a joint housing in which the joint is positioned.

According to an embodiment, the joint housing defines a concave surface with respect to the joint.

According to a preferred embodiment, the joint housing defines a ball-portion surface.

Advantageously, the geometric coupling between the conical or truncated cone wall of the joint and the ball-portion surface of the joint housing reduces the radial load acting on the recirculating ball 30 screw-nut screw assembly 33, and allows relative rotations and movements between the threaded shaft 32 and the thrust plate, and/or between the thrust plate and the joint.

According to an embodiment, the front shaft wall and the planar wall of the joint are made so that, when the actuation device 25 is actuated to apply a braking force, the static frictional force generated between the front shaft wall and the planar wall is lower than the static frictional force generated between the thrust plate and the disc brake pad, or than the static frictional force generated between the thrust plate and the conical or truncated cone wall of the joint.

Advantageously, the low friction between the front shaft wall and the planar wall reduces the radial stresses acting on the recirculating ball 30 screw-nut screw assembly 33.

Indeed, such a low friction causes the joint to act as a decoupler between the threaded shaft 32 and the thrust plate in case of radial load peaks due to the contact between the thrust plate and the disc brake pad.

According to such a configuration, during the application of the braking force, the disc brake pad cannot be supported by the threaded shaft 32, but is always supported by the disc brake caliper. Therefore, the tangential force applied by the brake disc to the pads is discharged onto the disc brake caliper, thus allowing the radial load acting on the front shaft wall to be reduced.

According to an embodiment, the actuation device 25 comprises a radial bearing.

The radial bearing is configured to sustain the radial stresses acting on the actuation device 25 and generated by the torque transmission from the gearmotor to the actuation device 25.

According to a preferred embodiment, the radial bearing is externally connected to the nut screw 33.

Even more preferably, the radial bearing is positioned to be adjacent to the thrust bearing 31, on the side facing the thrust plate.

Advantageously, such a configuration reduces the axial dimensions of the actuation device 25.

Preferably, the radial bearing is a “roller” type bearing. Alternatively, the radial bearing is a ball bearing.

According to an embodiment, the threaded shaft 32 is at least partially hollow in the axial direction, and forms an inner wall. The inner wall defines a through cavity. Alternatively, the inner wall defines an open blind cavity at the front shaft wall.

According to an embodiment, the through cavity extends between a front opening, defined at the front shaft wall, and a rear opening, defined at a rear shaft wall.

According to an embodiment, the inner wall of the threaded shaft 32 forms a backing step.

According to an embodiment, the backing step delimits a front cavity portion, extending between the backing step and the front opening, and a rear cavity portion, extending between the backing step and the rear opening.

The front cavity portion has a smaller radial section than the radial section of the rear cavity portion.

According to an embodiment, the actuation device 25 comprises a retaining screw configured to connect the threaded shaft 32 to the thrust plate in the axial direction. Therefore, by means of the retaining screw, a retraction of the threaded shaft 32 corresponds to a retraction of the thrust plate. The retaining screw thus ensured the detachment of the thrust plate from the disc brake pad so as to reduce any residual braking torque acting on the brake disc during the non-operation of the actuation device 25.

Moreover, the retaining screw forms a screw head and a threaded shank.

According to an embodiment, the screw head is connected to the threaded shaft 32 and is positioned inside the through-cavity and has an axial clearance with respect to the backing step, and the threaded shank extends through the front cavity portion and is connected to the thrust plate. Advantageously, the axial clearance of the screw head with respect to the backing step is such that the degrees of freedom granted by the joint are preserved. The retaining screw is configured to ensure that the retraction of the threaded shaft 32 also results in a retraction of the thrust plate.

According to an embodiment, the retaining screw has an axial and radial clearance with respect to the inner wall of the threaded shaft 32.

Advantageously, such a clearance is configured to allow rotational and/or translational displacements of the retaining screw, and thus of the thrust plate screwed thereto, with respect to the threaded shaft 32.

This effect is particularly advantageous in case of complete adhesion of the thrust plate to the disc brake pad during the deformation of the disc brake caliper under the action of the braking force.

According to an alternative embodiment, the actuation device 25 comprises a snap retaining connection configured to connect the threaded shaft 32 to the thrust plate in the axial direction.

The snap retaining connection comprises a threaded shank and a snap connection head.

The threaded shank is connected to the thrust plate, and the snap connection head is snap-connected to the threaded shaft 32.

According to an embodiment, the snap retaining connection is configured to be insertable into the blind cavity by means of a snap connection, such that it resists an extraction force from the blind cavity.

According to an embodiment, the snap connection head is positioned inside the blind cavity. The threaded shank extends through the blind cavity, exits from the front shaft wall, and is connected to the thrust plate.

The snap retaining connection is configured to ensure that the retraction of the threaded shaft 32 results in the retraction of the thrust plate. Therefore, by means of the snap retaining connection, a retraction of the threaded shaft 32 corresponds to a retraction of the thrust plate. The snap retaining connection thus ensures the detachment of the thrust plate from the disc brake pad, so as to reduce any residual braking torque acting on the brake disc during the non-operation of the actuation device 25.

According to a preferred embodiment, the snap connection head comprises a plurality of petals at least partially extending in a radial direction with respect to the shank.

The petals are configured to be elastically biased as they approach the axis of the threaded shank. The snap connection head and petals can thus be inserted into the blind cavity. Specifically, they are insertable beyond the backing step.

Upon the successful insertion into the blind cavity, the petals are configured to extend away from the axis of the threaded shank, so as to make a snap connection with the threaded shaft 32. Specifically, the petals release their elastic potential, extending again in an at least partially radial direction with respect to the threaded shank, as they pass the backing step.

Advantageously, such a configuration of the snap retaining connection accommodates any rotational and/or translational displacements of the snap retaining connection, and thus of the thrust plate screwed thereto, with respect to the threaded shaft 32.

According to another alternative embodiment, the actuation device 25 comprises a retaining pin, configured to connect the threaded shaft 32 to the thrust plate in the axial direction.

The retaining pin comprises a threaded shank and a pin head.

According to an embodiment, the pin head is coated with a polymer material. Preferably, the pin head is coated with a rubber overmolding.

According to an embodiment, the pin head defines at least one vent hole passing through the pin head in a direction parallel to the threaded shank.

Preferably, the pin head defines a plurality of vent holes.

Advantageously, by means of the vent holes the pin head coated with a polymer material acts as a suction cup. Therefore, the retaining pin, by means of the pin head thus configured, is connectable to the threaded shaft 32 by means of a “suction-cap” effect, i.e., by vacuum adhesion.

Advantageously, such as configuration of the retaining pin accommodates any rotational and/or translational displacement of the retaining pin, and thus of the thrust plate screwed thereto, with respect to the threaded shaft 32.

According to an embodiment, the pin head is positioned inside the blind cavity. The threaded shank extends through the blind cavity, exits from the front shaft wall, and is connected to the thrust plate. According to this configuration, the pin head adheres with a suction-cup effect to the inner wall defining the blind cavity.

The retaining pin is configured to ensure that the retraction of the threaded shaft 32 results in the retraction of the thrust plate. Therefore, by means of the retaining pin, a retraction of the threaded shaft 32 corresponds to a retraction of the thrust plate.

The retaining pin connection thus ensures the detachment of the thrust plate from the disc brake pad, so as to reduce any residual braking torque acting on the brake disc during the non-operation of the actuation device 25.

According to an embodiment, the rear plate wall forms a nut screw portion 33 extending axially in the direction of the threaded shaft 32.

According to this embodiment, the threaded shank is screwed to the nut screw portion 33 of the thrust plate.

Specifically, the threaded shank of the retaining screw, or the threaded shank of the snap retaining connection, or the threaded shank of the retaining pin is screwed to the nut screw portion 33 of the thrust plate.

According to a preferred embodiment, the nut screw portion 33 extends through the front opening of the threaded shaft 32, into the front cavity portion.

According to an embodiment, the joint defines a through-hole extending between the conical or truncated cone wall and the planar wall, and the nut screw 33 portion of the thrust plate extends through such a through-hole.

According to an embodiment, the actuation device 25 comprises a plug positioned inside the inner wall of threaded shaft 32.

The plug is configured to seal a through cavity defined by the inner wall.

Advantageously, the plug prevents the ingress of dust, moisture, liquids, or external contaminants that would deteriorate the components of the actuation device 25 located at the rear shaft wall, passing through the clearance between the retaining screw and the inner wall of the threaded shaft 32, or between the snap retaining connection and the inner wall, or the retaining pin and the inner wall.

According to a preferred embodiment, the plug is positioned inside the rear cavity portion of the through-hole.

According to an embodiment, the predetermined plug is positioned is behind the threaded shaft 32, at the rear wall of the threaded shaft 32, inside the bushing, and is configured to seal the rear wall of the threaded shaft 32.

Advantageously, the plug prevents the ingress of dust, moisture, liquids, or external contaminants that would deteriorate the components of the actuation device 25 located at the rear shaft wall, passing through the clearance between the retaining screw and the inner wall of the threaded shaft 32, or between the snap retaining connection and the inner wall, or the retaining pin and the inner wall.

According to an embodiment, the actuation device 25 comprises a dynamic seal positioned outside the nut screw 33 at the thrust plate.

The dynamic seal is configured to achieve a fluid seal between the nut screw 33 and the thrust plate.

According to another preferred embodiment, the dynamic seal is a “lip” type seal.

According to an embodiment, the actuation device 25 comprises a static seal connected to the thrust plate and extending radially outwards from the thrust plate.

The static seal is configured to achieve a fluid seal between the actuation device 25 and a disc brake pad.

Advantageously, the static seal protects the mechanical components of the actuation device 25 from contact with dust, moisture or other contaminants.

According to an embodiment, the nut screw 33 defines a circumferential housing. The circumferential housing is interposed between the outer toothing and the thrust plate.

The static seal is positioned in the circumferential housing.

According to an embodiment, the thrust plate defines a circumferential groove extending inwards from the thrust plate in the radial direction.

According to this embodiment, the static seal is positioned in the circumferential housing, and one end of the static seal is inserted into the circumferential groove.

According to another preferred embodiment, the static seal is a seal of the “bellows” type.

According to an embodiment, the actuating portion 25 comprises a lock ring.

The lock ring is located outside the nut screw 33. The lock ring is interposed with contact between the static seal and the outer toothing of the nut screw 33.

The lock ring is configured to hold actuation device 25 in the predetermined position inside the disc brake caliper.

According to an embodiment, one end of the lock ring is positioned abutting against the outer toothing. Advantageously, such an end abutting against the outer toothing prevents any disassembly of the actuation device 25 due to the vibrations generatable during the operation of the actuation device 25.

According to a preferred embodiment, the lock ring has an “S”- or “Z”-shaped profile along an axial section parallel to the actuation axis. According to this embodiment, one end of the lock ring abuts against the static seal and an opposite end of the lock ring abuts against the outer toothing.

According to an embodiment, the actuation device 25 comprises anti-rotation means.

The anti-rotation means are configured to allow a translation of the threaded shaft 32 in the axial direction and to prevent a rotation of the threaded shaft 32 about the axial direction.

Therefore, the anti-rotation means are configured to prevent the rotation of the nut screw 33 from rotating the threaded shaft 32.

According to an embodiment, the anti-rotation means comprise an anti-rotation pin engaged on the threaded shaft 32.

According to an embodiment, the anti-rotation means further comprise a bushing. The bushing is connected to the disc brake caliper by interference coupling.

The bushing is connected to threaded shaft 32. Specifically, the bushing is connected to the threaded shaft 32 at the rear wall of threaded shaft 32.

The bushing defines a bushing slot passing radially and extending in the axial direction.

According to this embodiment, the anti-rotation pin is engaged on the threaded shaft 32, and passes through the bushing slot.

According to an embodiment, the bushing is made of aluminum.

According to an embodiment, the thrust bearing 31 and/or the force sensor 29 are connected to the bushing.

Preferably, the bushing is positioned externally about the threaded shaft 32 at the rear end of the threaded shaft 32.

According to an embodiment, the recirculating ball 30 screw-nut screw assembly 33, the retaining screw and anti-rotation pin are made of steel.

According to a further aspect of the invention, the disc brake comprises a caliper comprising two side walls mutually spaced apart and delimiting a disc space to accommodate a portion of a brake disc, means for fixing the caliper to a vehicle, a connection structure which extends straddling the disc space and connects the side walls to each other, at least one pad housing formed in each of said side walls and adapted to accommodate at least one pad, thrust means constrained to one or both side walls and adapted to bias the pads against the brake disc to clamp it, where the thrust means comprise the actuation device 25 as described above.

Moreover, the disc brake comprises a gearmotor and a transmission system 26 configured to transmit mechanical power generated by the gearmotor to the nut screw 33 of the actuation device 25.

According to an embodiment, the transmission system 26 comprises a gear meshed with the outer toothing of the nut screw 33.

Obviously, those skilled in the art will be able to make changes or adaptations to the present invention, without however departing from the scope of the following claims.

### LIST OF REFERENCE NUMERALS

1. Brake caliper
2. Disc brake
3. Side walls
4. Caliper body
5. Pad
6. Transmission housing
7. Control housing
8. Electric motor
9. Motor housing
10. Control compartment
11. Drive shaft
12. Actuation axis
13. Electronic board
14. Motor housing wall
15. Electric connectors
16. Main electric connector
17. Metal cover
18. Electromechanical parking brake
19. Rear end of drive shaft
20. Electromechanical actuator
21. Toothed wheel
22. Selector element
23. Conductive track
24. Position sensor
25. Actuation device
26. Transmission system
27. First housing compartment
28. Second housing compartment
29. Force sensor
30. Recirculating ball screw-nut screw assembly
31. Thrust bearing
32. Threaded shaft
33. Nut screw
34. Auxiliary electronic board
35. Auxiliary control compartment

1-16. (canceled)

17. A brake caliper for a disc brake, comprising:
a caliper body comprising:
two mutually distanced side walls which delimit a disc space for accommodating a portion of a brake disc;
a connection structure which extends straddling the disc space and connects the side walls to each other; and
at least one pad housing formed in each of said side walls and adapted to accommodate at least one pad;
a transmission housing extending between a front wall thereof and an opposite rear wall thereof, wherein the transmission housing is connected to the caliper body so that the front wall of the transmission housing faces the disc space;
thrust means adapted to bias the pads against the brake disc along an actuation axis transverse to the side walls, said thrust means being at least partially accommodated within the transmission housing;
a control housing connected to the transmission housing at the rear wall of the transmission housing,
wherein the control housing supports and accommodates:
an electric motor comprising a drive shaft, wherein the electric motor is configured to generate and transfer mechanical power to the thrust means through the drive shaft, said electric motor being at least partially housed inside a motor housing formed by the control housing;
a brake control unit configured to control the electric motor, said brake control unit being housed within a control compartment defined by the control housing;
wherein the electric motor is electrically connected to the brake control unit,
wherein the drive shaft extends in a direction parallel to the actuation axis, and protrudes from a front side of the electric motor facing the caliper body,
wherein the brake control unit comprises at least one electronic board, and
wherein said at least one electronic board extends in a transverse direction with respect to the actuation axis.

18. The brake caliper of claim 17, wherein the electric motor is entirely housed inside the motor housing.

19. The brake caliper of claim 17, wherein the electric motor is welded to the control housing, inside the motor housing.

20. The brake caliper of claim 17, wherein the motor housing has a substantially cylindrical shape, defined by a motor housing wall having a cylindrical shape coaxial to the drive shaft, and wherein the motor housing wall of the control housing extends into the transmission housing, through the rear wall of the transmission housing, and, optionally, wherein the electric motor comprises a rotor and a stator, and said stator and the motor housing wall are made in one piece, optionally by molding.

21. The brake caliper of claim 17, wherein at least one portion of the at least one electronic board faces a rear side of the electric motor opposite to the front side of the electric motor from which the drive shaft extends, and wherein electrical connectors extend from the rear side of the electric motor to the at least one electronic board, to electrically connect the electric motor to the at least one electronic board.

22. The brake caliper of claim 17, wherein the control housing comprises a main electric connector configured to be accessible from outside the brake caliper, to receive electrical power and signals from an electronic control unit installed in a vehicle, and to transfer the electrical power and signals to the brake control unit,
wherein, optionally, the main electric connector is positioned on a rear side of the control housing facing away from the transmission housing,
and/or wherein the main electric connector faces a side of the at least one electronic board opposite to a side of the at least one electronic board electrically connected to the electric motor,
or wherein the main electric connector faces an edge of the at least one electronic board, at a position substantially coplanar to a plane defined by the at least one electronic board.

23. The brake caliper of claim 17, wherein the transmission housing is made of a material having a higher thermal conductivity than a thermal conductivity of a material with which the control housing is made, and wherein, optionally, the control housing is made of a polymeric material and the transmission housing is made of a metallic material.

24. The brake caliper of claim 17, wherein the control compartment of the control housing is open at a rear side of the control housing,
wherein the brake caliper comprises a metal cover connected to the control housing so as to close the rear side of the control housing,
wherein the metal cover is configured to dissipate heat coming from the control housing to an outside of the brake caliper, and
wherein the metal cover is made of a material having a higher thermal conductivity than a thermal conductivity of a material of which the control housing is made.

25. The brake caliper of claim 24, wherein the control housing is shaped so as to prevent contact between the metal cover and the transmission housing.

26. The brake caliper of claim 24, wherein the metal cover is connected to the control housing so that the metal cover is in direct contact with the brake control unit, or wherein the metal cover is in indirect contact with the brake control unit, and highly thermally conductive means are interposed between the metal cover and the brake control unit.

27. The brake caliper of claim 17, wherein the drive shaft comprises a drive shaft rear end that protrudes from a rear side of the electric motor facing opposite to the transmission housing,
wherein the brake caliper further comprises a position sensor configured to detect an angular positioning of the electric motor,
wherein the position sensor is positioned within the control housing and is electrically connected to the brake control unit, wherein the position sensor is preferably positioned inside the control compartment, and
wherein the position sensor is positioned at the drive shaft rear end, interposed between the electric motor and the at least one electronic board,
or wherein the position sensor is mounted on the at least one electronic board,
or wherein the control housing comprises a motor control board integrated into the electric motor, said motor control board being interconnected with the brake control unit and being configured to control the electric motor, and wherein the position sensor is mounted on said motor control board.

28. The brake caliper of claim 17, wherein the drive shaft comprises a drive shaft rear end that protrudes from a rear side of the electric motor facing opposite to the transmission housing,
wherein the brake caliper further comprises an electromechanical parking brake,
wherein the electromechanical parking brake is housed inside the control compartment of the control housing, and
wherein the electromechanical parking brake is electrically connected to the brake control unit of the control housing.

29. The brake caliper of claim 28, wherein the drive shaft rear end extends through the at least one electronic board in a through-hole made in the at least one electronic board,
wherein the electromechanical parking brake comprises a toothed wheel integrally fixed to the drive shaft rear end,
wherein the toothed wheel comprises at least one tooth, preferably between one and eight teeth,
wherein the electromechanical parking brake comprises an electromechanical actuator configured to translate in a direction of the teeth of the toothed wheel, transversely to a rotation axis of the toothed wheel, and
wherein the electromechanical actuator is configured to wedge itself between the teeth of the toothed wheel, following a control of the brake control unit, to prevent a rotation of the toothed wheel and to stop a rotation of the drive shaft.

30. The brake caliper of claim 29, wherein the electromechanical actuator comprises a coupling element configured to be elastically biased against the toothed wheel to engage between the teeth of the toothed wheel and stop the rotation of the toothed wheel,
wherein the teeth of the toothed wheel and the coupling element are shaped so that the coupling element allows the rotation of the toothed wheel in one direction of rotation, but prevents the rotation of the toothed wheel in an opposite direction of rotation,
wherein the electromechanical actuator comprises a selector element slidable between a first position, in which the selector element biases the coupling element into a coupling position between the teeth of the toothed wheel, and a second position, in which the selector element biases the coupling element into an uncoupling position, spaced apart from the teeth of the toothed wheel,
wherein, optionally, the electromechanical actuator comprises a cam member configured to allow the selector element to slide into the first position, and actuate a mechanical lock which prevents the selector element from returning to the second position, and preserve a parking braking operation,
and/or wherein the toothed wheel comprises a plurality of teeth distributed along a periphery of the toothed wheel, mutually equidistant according to a pitch having a predetermined value, and/or wherein the teeth of the toothed wheel are substantially equal to each other.

31. The brake caliper of claim 29, wherein the electromechanical parking brake is electrically connected to the brake control unit through a conductive track overmolded on the control housing, and wherein the conductive track is electrically connected to the electromechanical actuator of the electromechanical parking brake.

32. The brake caliper of claim 17, further comprising an actuation device and a transmission system,
wherein the transmission system is configured to transmit a torque generated by the electric motor to the actuation device,
wherein the actuation device is configured to convert the torque received from the transmission system into a braking force directed against the pads, along the actuation axis,
wherein the transmission housing defines a first housing compartment and a second housing compartment,
wherein the first housing compartment and the second housing compartment are mutually parallel and extend in a direction parallel to the actuation axis,
wherein the electric motor, housed within the control housing, is positioned inside the first housing compartment,
wherein the transmission system, connected to the electric motor, is positioned inside the first housing compartment,
wherein the actuation device is positioned inside the second housing compartment,
wherein the first housing compartment is communicating with the second housing compartment so that the transmission system is connectable to the actuation device, and
wherein, optionally, the first housing compartment has a substantially cylindrical shape coaxial to the drive shaft, and the second housing compartment has a substantially cylindrical shape coaxial to the actuation axis.

33. The brake caliper of claim 32, wherein the transmission housing comprises a force sensor,
wherein the force sensor is connected to the actuation device, on a rear side of the actuation device facing towards the control housing,
wherein the force sensor is configured to detect the braking force applied by the actuation device, and
wherein the force sensor is electrically connected to the brake control unit.

34. The brake caliper of claim 33, wherein a front side of the force sensor faces the actuation device, and an opposite rear side of the force sensor faces at least one portion of the at least one electronic board, and wherein electrical connectors extend between the force sensor and the at least one electronic board, through an interface between the transmission housing and the control housing.

35. The brake caliper of claim 17, wherein the brake control unit comprises at least one auxiliary electronic board,
wherein the at least one auxiliary electronic board is housed inside the control housing, transversely relative to the at least one electronic board,
wherein the auxiliary electronic board extends at least partially above the transmission housing, adjacent to the connection structure,
wherein the control housing defines an auxiliary control compartment extending in a substantially transverse direction relative to the control compartment,
wherein the at least one auxiliary electronic board is housed inside the auxiliary control compartment,
wherein, optionally, the at least one auxiliary electronic board is connected to the at least one electronic board at an edge of the at least one electronic board so that the brake control unit comprising the at least one electronic board and the at least one auxiliary electronic board is substantially “L”-shaped, and
wherein, optionally, the at least one electronic board is a power board and the at least one auxiliary electronic board is a logic board.

36. A disc brake comprising the brake caliper of claim 17.
